(19) United States
(12) Patent Application Publication
(10) Pub. No.: US 2016/0190619 A1
(43) Pub. Date: Jun. 30, 2016

(54) CONTROL METHOD OF FUEL CELL SYSTEM, FUEL CELL AUTOMOBILE, AND FUEL CELL SYSTEM

(71) Applicant: HONDA MOTOR CO., LTD., Tokyo (JP)

(72) Inventor: Shuichi KAZUNO, Wako (JP)

(73) Assignee: HONDA MOTOR CO., LTD., Tokyo (JP)

(21) Appl. No.: 14/972,087

(22) Filed: Dec. 17, 2015

(30) Foreign Application Priority Data
Dec. 25, 2014 (JP) 2014-263334

(51) Int. Cl. H01M 8/04828; H01M 8/04746; B60L 11/18; H01M 8/04082

(52) U.S. Cl. CPC H01M 8/04888; H01M 8/04201; H01M 8/04776; B60L 11/1881; H01M 2250/20

(57) ABSTRACT

A control method of a fuel cell system includes generating electricity in a fuel cell through reaction of an oxidant gas and a fuel gas so as to output a fuel cell voltage. An electric storage device voltage is outputted from an electric storage device. The electric storage device voltage serves as a primary side voltage. A motor driving voltage serves as a secondary side voltage and is to be applied to a motor driving device to drive a motor. The primary side voltage is applied to an air pump driving device to drive an air pump so as to supply the oxidant gas to the fuel cell. A required air pump voltage to apply to the air pump driving device is set. The electric storage device voltage is set so as to satisfy the required air pump voltage.

### CROSS-REFERENCE TO RELATED APPLICATIONS

The present application claims priority under 35 U.S.C. §119 to Japanese Patent Application No. 2014-263334, filed Dec. 25, 2014, entitled “Control Method of Fuel Cell System, and Fuel Cell Automobile.” The contents of this application are incorporated herein by reference in their entirety.

### BACKGROUND

1. Field

The present disclosure relates to a control method of a fuel cell system, a fuel cell automobile, and a fuel cell system.

2. Description of the Related Art

There has previously been disclosed a fuel cell system having a voltage transducer (DC/DC converter) that converts electric storage device voltage serving as primary side voltage (battery voltage) into motor driving voltage serving as secondary side voltage, and applies this motor driving voltage to a motor driving unit (inverter), as illustrated in FIG. 1 of Japanese Unexamined Patent Application Publication No. 2007-157478, for example. The fuel cell system disclosed in Japanese Unexamined Patent Application Publication No. 2007-157478 uses technology for applying the electric storage device voltage serving as primary side voltage to a pump or the like to supply oxidant gas to the fuel cell.

Japanese Unexamined Patent Application Publication No. 2013-198284 discloses an external power supply system where the electric storage device voltage serving as primary side voltage is supplied to an external load through an external electric power supply inverter. In this arrangement, where an external electric power supply system is connected to the electric storage device, the voltage supplied as driving voltage to the external electric power supply inverter of the external electric power supply system is decided in accordance with the state of charge (SOC) of the electric storage device, i.e., the remaining charge.

### SUMMARY

According to a first aspect of the present invention, a control method of a fuel cell system includes generating electricity in a fuel cell through reaction of an oxidant gas and a fuel gas so as to output a fuel cell voltage. An electric storage device voltage is outputted from an electric storage device. The control method includes converting from the electric storage device voltage to a motor driving voltage or from the motor driving voltage to the electric storage device voltage. The electric storage device voltage serves as a primary side voltage. The motor driving voltage serves as a secondary side voltage and is to be applied to a motor driving device to drive a motor. The primary side voltage is applied to an air pump driving device to drive an air pump so as to supply the oxidant gas to the fuel cell. A required air pump voltage to apply to the air pump driving device is set. The electric storage device voltage is set so as to satisfy the required air pump voltage.

According to a second aspect of the present invention, a fuel cell system includes a fuel cell, an electric storage device, a motor, a voltage transducer, an air pump, and a controller. The fuel cell is to generate electricity through reaction of an oxidant gas and a fuel gas so as to output a fuel cell voltage. The electric storage device is to output an electric storage device voltage. The motor is to be driven through a motor driving device. The voltage transducer is to convert from the electric storage device voltage to a motor driving voltage or from the motor driving voltage to the electric storage device voltage. The electric storage device voltage serves as a primary side voltage. The motor driving voltage serves as a secondary side voltage and is to be applied to the motor driving device. The air pump is to be driven through an air pump driving device so as to supply the oxidant gas to the fuel cell. The primary side voltage is to be applied to the air pump driving device. The controller is configured to set a required air pump voltage to apply to the air pump driving device and configured to set the electric storage device voltage so as to satisfy the required air pump voltage.

According to a third aspect of the present invention, a fuel cell automobile includes the fuel cell system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an schematic overall configuration diagram of a fuel cell automobile to which a fuel cell system according to an embodiment of the present disclosure has been applied.

FIG. 2 is a schematic circuit diagram including a detailed configuration of an example of a step up converter and step up/down converter in the fuel cell automobile in the example illustrated in FIG. 1.

FIG. 3 illustrates a current-voltage characteristic curve of a fuel cell.

FIG. 4 is a properties diagram illustrating the relationship between requested air pump revolutions and required air pump voltage.

FIG. 5 is a properties diagram illustrating the relationship between electric power of an electric storage device and voltage of the electric storage device, with the SOC of an electric storage device and the temperature of the electric storage device as parameters.

FIG. 6 is a timing chart provided for description of operations of low-temperature running control, where the SOC of the electric storage device is variable.

FIG. 7 is a flowchart provided for description of operations of low-temperature running control, where the SOC of the electric storage device is variable.

FIG. 8 is a properties diagram illustrating the relationship between requested motor electric power and required motor voltage.

FIG. 9 is a timing chart provided for description of operations of low-temperature running control, where the electric storage device electric power is restricted.

FIG. 10 is a flowchart provided for description of operations of low-temperature running control, where the electric storage device electric power is restricted.

FIG. 11 is a conceptual diagram illustrating an operating state of the fuel cell automobile during external power supply.

FIG. 12 is a timing chart provided for description of operations of external electric power supply in a case where the SOC is higher than the target SOC at the time of starting external electric power supply.

FIG. 13 is a timing chart provided for description of operations of external electric power supply in a case where the SOC is lower than the target SOC at the time of starting external electric power supply.

FIG. 14 is a flowchart provided for description of operations of external electric power supply control.

FIG. 15 is a properties diagram illustrating the relationship between required air pump voltage and various types of efficiency.

FIG. 16 is a properties diagram illustrating the relationship between electric power of the electric storage device and voltage of the electric storage device, with the SOC of an electric storage device as a parameter.

FIG. 17A is a conceptual diagram of a fuel cell automobile to which the fuel cell system according to the embodiment has been applied.

FIG. 17B is a conceptual diagram of a fuel cell automobile to which the fuel cell system according to another embodiment has been applied.

### DESCRIPTION OF THE EMBODIMENTS

The embodiments will now be described with reference to the accompanying drawings, wherein like reference numerals designate corresponding or identical elements throughout the various drawings.

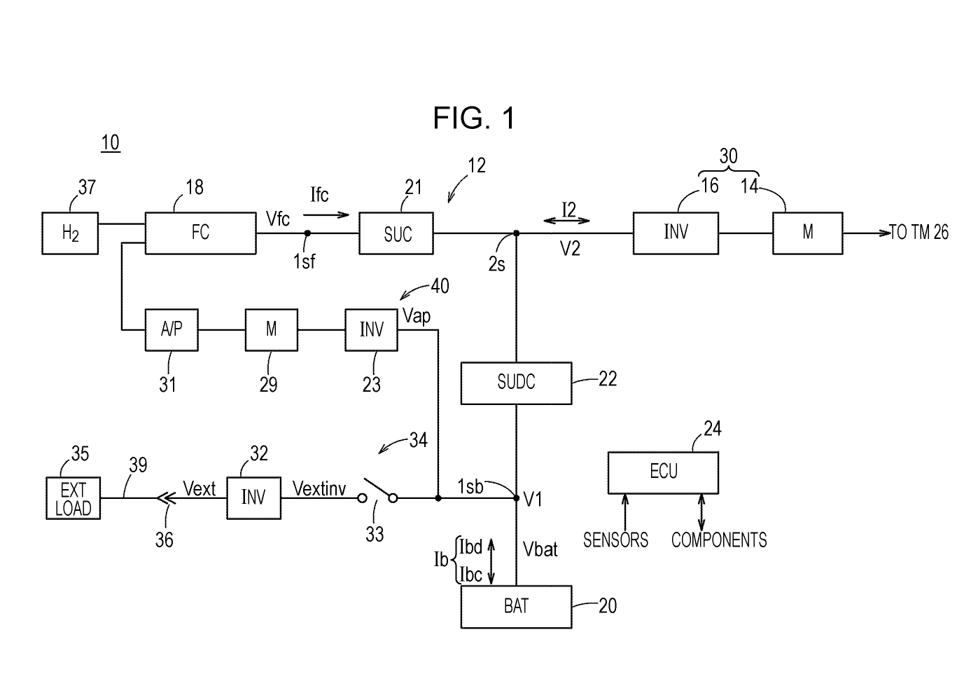

A control method of a fuel cell system according to the present disclosure will be described by way of an embodiment with regard to the relationship between the control method and a fuel cell automobile for carrying out the control method, with reference to the attached drawings. FIG. 1 is an overall schematic configuration diagram of a fuel cell automobile 10 (hereinafter referred to as “FC automobile 10” or simply “vehicle 10”) to which a fuel cell system 12 (hereinafter referred to as “FC system 12”) according to the present embodiment.

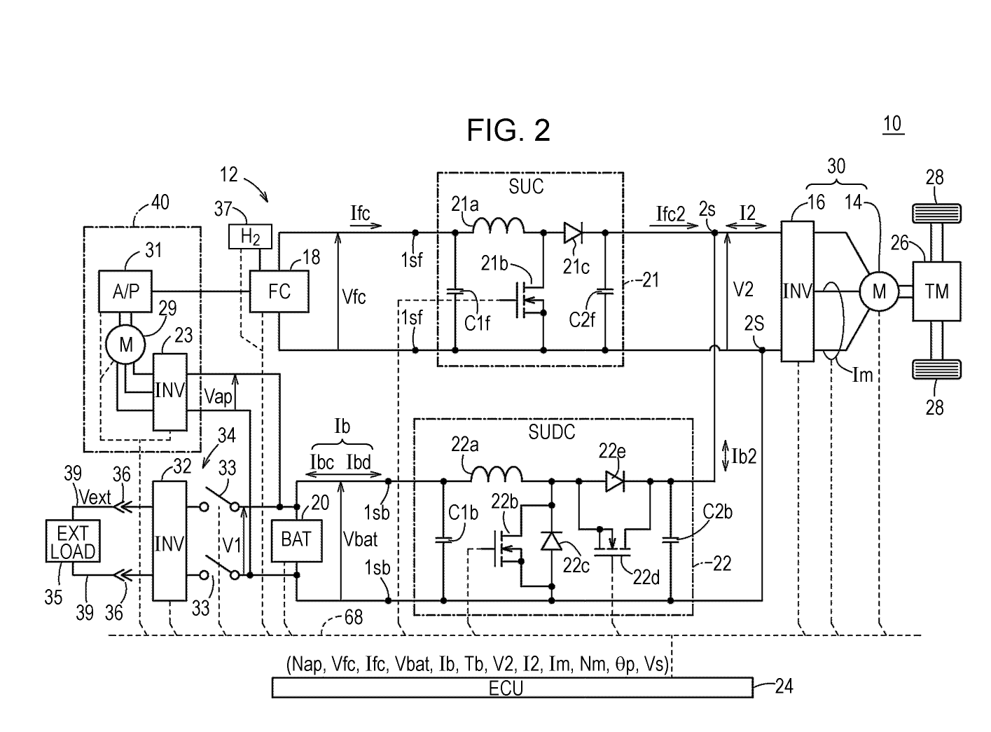

FIG. 2 is a schematic circuit diagram of the FC automobile 10, including a detailed configuration of an example of a chopper-type step-up converter (SUC) 21 (hereinafter referred to as “SUC 21”) which is a fuel cell side converter disposed between a primary side 1sb and a secondary side 2s, serving as a first transducer (boost converter) and a chopper-type both-way step-up/down converter (SUDC) 22 (hereinafter referred to as “SUDC 22”) which is a electric storage device side converter disposed between the primary side 1sb and the secondary side 2s, serving as a second transducer (boost-buck converter).

The FC automobile 10 includes the FC system 12, a driving motor 14 that is a motor generator whereby the vehicle can run, an inverter (INV) 16 (hereinafter referred to as “INV 16”) serving as a load driving circuit (motor driving circuit), and an external electric power supply unit 34.

The FC system 12 basically includes a fuel cell device 18 (hereinafter referred to as “FC 18”) disposed at one primary side 1sf, a high-voltage battery 20 (hereinafter referred to as “BAT 20”) that is an electric storage device disposed at another primary side 1sb, the SUC 21, the SUDC 22, an air pump unit 40 that inputs primary side voltage V1, the external electric power supply unit 34 that inputs the primary side voltage V1, and an electronic control unit (ECU) 24 (hereinafter referred to as “ECU 24”) serving as a control device.

The air pump unit 40 includes an air pump (AP) 31 that pumps air to the FC 18, an air pump motor 29, and an air pump inverter (INV) 23 (hereinafter referred to as “INV 23”) serving as an air pump driving unit that drives the air pump 31 via the air pump motor 29.

The external electric power supply unit 34 is configured including an external electric power supply inverter 32 serving as an external electric power supply drive unit to which an external electric power supply connector 36 is connected, and an external electric power supply switch 33 which only is in an on state (closed state) when an ignition switch, omitted from illustration, is switched to an external electric power supply position. The ignition switch is switched to either one or the other of a run-enabled position (drive position) and the external electric power supply position. The external electric power supply switch 33 is in an off state (open state) when at a running enabled position or the like.

Upon an external load 35 being connected (mounted) to the external electric power supply connector 36 via an external electric power supply cord (power feed line) 39 when the FC automobile 10 is parked or the like, and the external electric power supply switch 33 being turned to an on state, FC electric power (generated electric power) Pfc of the FC 18 is supplied to the external load 35 via the SUC 21, SUDC 22, external electric power supply switch 33, external electric power supply inverter 32, external electric power supply connector 36, and external electric power supply cord (power feed line) 39. Note that basically, settings are performed so that only the FC electric power Pfc is supplied to the external load 35 via the external electric power supply inverter 32. That is to say, the BAT voltage Vbat of the BAT 20 is set to an open circuit voltage (OCV) Vbatocv where there is no electric power balance (charging/discharging).

The external electric power supply inverter 32 is configured including, for example, an H-bridge circuit and an output transformer, and converts BAT voltage Vbat (external inverter voltage Vextinv) serving as the primary side voltage V1, into external electric power supply voltage Vext which is commercial AC voltage. In this case, a modification may be made to the configuration so that the external electric power supply voltage Vext is supplied as a constant DC voltage, and an inverter (DC voltage to commercial AC voltage converter) is provided at the side of a house to supply to the external load 35. From the perspective of cost and the like, the external load 35 is normally set low, to around ½ to 1/100 of the internal load of the FC automobile 10 including the load 30 such as the driving motor 14 and so forth.

The output end of the FC 18 is connected to the input end (primary side 1sf) of the SUC 21, and the output end (secondary side 2s) of the SUC 21 is connected to the DC end side of the INV 16 and one end side (boost end side) of the SUDC 22. Connected to the other end side (step-down end side) of the SUDC 22 is the DC end side of the air pump inverter 23, the DC end side of the external electric power supply inverter 32 connected via the external electric power supply switch 33, and the input/output ends of the BAT 20. That is to say, the primary side voltage V1 is applied to the air pump inverter 23 as air pump driving voltage Vap, and also is applied to the external electric power supply inverter 32 as external inverter voltage Vextinv (see FIG. 1 as well). Note a low-voltage battery such as +12 V or the like, and low-voltage components such as the ECU 24, lights, and so forth, are connected to the input/output ends of the BAT 20 via a step-down converter omitted from illustration.

FC generated electric power (FC electric power) Pfc (where Pfc=Vfc×Ifc) supplied from the FC 18 and BAT discharge electric power Pbatd (where Pbatd=Vbat×Ibd) that is stored electric power supplied from the BAT 20 are combined to form a combined electric power (Pfc+Pbatd). Electric power of a value of this combined electric power is supplied to the driving motor 14 via the INV 16, whereby the driving motor 14 generates driving force, and rotates wheels 28 (driving wheels) by this driving force through a transmission 26.

The INV 16 has a three-phase full-bridge configuration for example, and performs DC-to-AC conversion, in which secondary side voltage V2, that is DC voltage obtained by the BAT voltage Vbat from the BAT 20 having been boosted by the SUDC 22, is converted into three-phase AC voltage and supplied to the driving motor 14 (when power running). This secondary side voltage V2 is obtained by the DC FC voltage Vfc from the FC 18 being boosted at the SUC 21. The INV 16 also performs conversion into three-phase AC voltage, and supplies to the driving motor 14 (when power running), secondary side voltage V2 obtained by boosting DC BAT voltage Vbat from the BAT 20 at the SUDC 22. That is to say, the driving motor 14 is driven by electric power from the FC 18 and/or BAT 20.

The INV 16 and the driving motor 14 together are called “load 30” in the present embodiment. In reality, the load of the FC automobile 10 includes, in addition to the load 30, the air pump unit 40, an air conditioning device that is omitted from illustration, and the aforementioned low-voltage components.

On the other hand, the secondary side voltage (DC end side voltage) V2 generated at the secondary side 2s of the input end (DC end) of the INV 16 after AC-to-DC conversion occurring due to regenerative operations at the driving motor 14 is either stepped down to BAT voltage Vbat at the SUDC 22 serving as a step-down converter and supplied to the BAT 20, or supplied to the BAT 20 in a state where the SUDC 22 is directly connected (switching device 22b off and switching device 22d on), thereby charging the BAT 20. In a case where driving power for the driving motor 14 from the FC 18 has become excessive, the excess electric power is charged to the BAT 20 by being supplied through the SUC 21 in a boosting state or directly-connected state, and the SUDC 22 in a step-down state or directly-connected state.

The air pump inverter 23 serving as an air pump driving unit also has a three-phase full-bridge configuration for example, and drives the air pump motor 29. The air pump 31 driven by the output of the air pump motor 29 supplies compressed air including oxygen (oxidant gas) from a channel inlet manifold to a cathode channel (omitted from illustration) of the FC 18, by a fan of the air pump 31 being rotated.

A hydrogen tank 37 that supplies hydrogen (fuel gas) to an anode channel (omitted from illustration) of the FC 18 is provided externally to the FC 18. Note that the hydrogen and oxidant gas are each called “reactant gas”. The FC 18 has a stack structure where cells of the fuel cell device (hereinafter referred to as “FC cells”), formed by an electrolytic film being sandwiched between an anode electrode and cathode electrode, have been layered. Hydrogen-containing gas supplied to the anode electrode through the anode channel is converted into hydrogen ions at an electrode catalyst, and moves through the electrolytic film to the cathode electrode. Electrons generated during this movement are extracted to an external circuit, and provided for use as electric energy generating DC voltage (FC voltage Vfc). The oxidant gas (oxygen-containing gas) is supplied to the cathode electrode via the cathode channel. The hydrogen ions, electrons, and oxidant gas react at this cathode electrode, thereby generating water. Generating water enables the electrolytic film to be maintained in a moist state with a high water inclusion percentage (film humidity), and the reaction can thus be smoothly carried out.

The BAT 20 is an electric storage device (energy storage) including multiple battery cells. Examples include lithium-ion secondary batteries, nickel-hydrogen secondary batteries, and so forth. A capacitor may be also used as the electric storage device. A lithium-ion secondary battery is used in the present embodiment. BAT voltage (battery voltage) Vbat, BAT current (battery current) Ib (discharge current Ibd and charging current Ibc), and BAT temperature (battery temperature) Tb, of the BAT 20, as well as the SOC which is the remaining charge in the BAT 20, are detected and managed by the ECU 24.

As described above, the FC electric power Pfc of the FC 18 is boosted to the secondary side voltage V2 by the SUC 21 and supplied to the driving motor 14 via the INV 16, while the secondary side voltage V2 is reduced to the primary side voltage V1 by the SUDC 22 and supplied to the air pump 31 as air pump driving voltage Vap via the air pump inverter 23 and air pump motor 29 (when power running).

During electric power supply with the external electric power supply switch 33 at the on state, The BAT voltage Vbat is set to open-circuit voltage Vbatocv, and the FC electric power Pfc is supplied to the external electric power supply unit 34 through the SUC 21 in a boosting state or directly-connected state, and the SUDC 22 in a step-down state or directly-connected state. On the other hand, the BAT discharge electric power Pbatd of the BAT 20 is boosted by secondary side voltage V2 at the SUDC 22 as BAT voltage Vbat and supplied to the driving motor 14 via the INV 16 (when power running). Also, the BAT voltage Vbat is applied to the air pump unit 40 as air pump driving voltage Vap when starting the FC automobile 10 or the like, and further the BAT voltage Vbat is applied to the external electric power supply unit 34 in accordance with the power state of the FC system 12.

Although various configurations can be used for the SUC 21 and SUDC 22, basically, these are configured including switching devices such as MOSFETs, IGTBs, or the like, diodes, reactors, and capacitors (including smoothing capacitors), with the switching devices being subjected to on/off switching control (duty control) by the ECU 24 based on the requested electric power of the load being connected, which is publically known. Specifically, the SUC 21 is configured including a reactor (inductor) 21a, a switching device 21b, a diode 21c (an element that allows current to pass in one direction and prevents current from flowing in the opposite direction), a smoothing capacitor C1f disposed across the primary side 1sf, and a smoothing capacitor C2f disposed across the secondary side 2s, as illustrated in FIG. 2. The FC voltage Vfc is boosted to the predetermined secondary side voltage V2 by the switching device 21b being placed in a switching state (duty state) by way of the ECU 24 serving as a converter controller.

If the duty (driving duty) is 0% and the switching device 21b is kept in an off state (open state), the FC 18 and load 30 are in a directly connected state via the reactor 21a and diode 21c (hereinafter referred to as “FC direct-connection state” or “FCVCU direct-connection state”, and the FC voltage Vfc is directly connected to the secondary side voltage V2 (V2=Vfc−Vd≈Vfc and Vd<<Vfc, where Vd represents the forward voltage drop of the diode 21c). The diode 21c acts to boost or to direction connect and prevent backflow. Accordingly, in addition to boosting operations (when power running or the like), the SUC 21 also performs backflow prevention operations and direct connection operations (when power running or the like).

On the other hand, the SUDC 22 is configured including a reactor 22a, switching devices 22b and 22d, diodes 22c and 22e respectively connected in parallel with these switching devices 22b and 22d, a smoothing capacitor C1b disposed across the primary side 1sb, and a smoothing capacitor C2b disposed across the secondary side 2s. When boosting, the ECU 24 puts the switching device 22b in an off state, and switching (duty control) the switching device 22b boosts the BAT voltage Vbat (electric storage device voltage) to the predetermined secondary side voltage V2 (when power running). When reducing, the ECU 24 puts the switching device 22b in an off state, and switching (duty control) the switching device 22d causes the diode 22c to function as a flywheel diode when the switching device 22d is in an off state, so the secondary side voltage V2 drops to the BAT voltage Vbat of the BAT 20 (during regeneration charging and/or charging by the FC 18).

If the duty (driving duty) of the switching device 22b is 0% in an off state, and the duty of the switching device 22d is 100% in an on state, the SUDC 22 is in a directly-connected state, i.e., the BAT 20 and load 30 are in a directly-connected state (when power running, charging, or when driving component loads or the like, hereinafter also referred to as “BAT direct-connection state”). In the BAT direct-connection state, the BAT voltage Vbat of the BAT 20 is the secondary side voltage V2 (Vbat≈V2). In practice, the secondary side voltage V2 of the BAT 20 in the BAT direct-connection state when power running is “Vbat−forward voltage drop of diode 22e”, and the secondary side voltage V2 when charging (including regeneration charging) is “Vbat=V2−on voltage of switching device 22b=Vbat (assuming that the on voltage of the switching device 22d is 0 V)”. Note that electric power devices such as IGBTs or the like may be used for the switching devices 21b, 22b, and 22d, besides the illustrated MOSFETs, as described earlier.

Arrangements, omitted from illustration, may be made to the FC system 12, where a diode is provided of which the anode terminal is connected to the primary side 1sf of the SUC 21 and the cathode terminal is connected to the secondary side 2s and/or a diode is provided of which the anode terminal is connected to the primary side 1sb of the SUDC 22 and the cathode terminal is connected to the secondary side 2s, to reduce DC voltage drop at the SUC 21 or SUDC 22 when the SUC 21 is directly connected, which is synonymous with the FC 18 being directly connected, or when the SUDC 22 is directly connected (when power running), which is synonymous with the BAT 20 being directly connected.

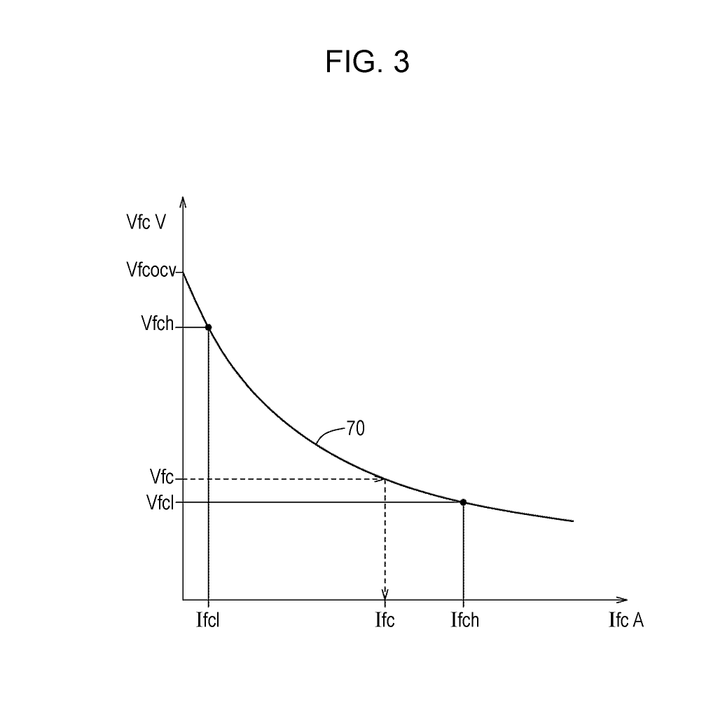

The FC 18 has a known current-voltage (IV) characteristic 70 where the lower the FC voltage Vfc is than the FC open-circuit voltage Vfcocv, the more the FC current Ifc increases, as illustrated in FIG. 3. That is to say, an FC current Ifch in a case where the FC voltage Vfc is a relatively low FC voltage Vfcl is a greater current in comparison with an FC current Ifcl in a case where the FC voltage Vfc is a relatively high FC voltage Vfch. Note that the larger the FC current Ifc is (the lower the FC voltage Vfc is), the larger the FC power Pfc is.

The FC voltage Vfc of the FC 18 is controlled by the secondary side voltage V2 decided by the boost ratio (V2/Vbat) of the SUDC 22 in a boosting state (switching state) or the drop ratio (Vbat/V2) of the SUDC 22 in a reducing state (switching state). The secondary side voltage V2 serves as a command voltage (target voltage) of the SUDC 22. Once the FC voltage Vfc is decided, the FC current Ifc is controlled (decided) following the IV characteristic 70. When the SUC 21 is boosting and the SUDC 22 is directly connected, the voltage at the primary side 1sf of the SUC 21, i.e., the FC voltage Vfc serves as the command voltage (target voltage) of the SUC 21, the FC current Ifc is decided following the IV characteristic 70, and the boost ratio (V2/Vfc) of the SUC 21 is decided so as to be a desired secondary side voltage V2.

Feedback (FB) control is performed in the present embodiment where the duty of the switching device 21b is adjusted by the ECU 24 serving as a converter controller when the SUC 21 is boosting, so that the FC voltage Vfc is at a command value (set value, target value). However, since the FC voltage Vfc and the FC current Ifc are in a unique relationship based on current-voltage characteristics, feedback (FB) control may be performed where the duty of the switching device 21b is adjusted by the ECU 24 so that the FC current Ifc is at a command value (set value, target value).

The ECU 24 controls the driving motor 14, INV 16, FC 18, BAT 20, SUC 21, SUDC 22, air pump unit 40, external electric power supply unit 34, and like components, via a communication line 68 (see FIG. 2). This control is performed by executing a program stored in memory (read only memory (ROM)) of the ECU 24, using detection values of various sensors and on/off information of various switches. The various sensors include a voltage sensor, current sensor, temperature sensor, pressure sensor, hydrogen concentration sensor, various types of revolution sensors, accelerator pedal angle sensor, and so forth, all omitted from illustration. The switches include an air condition switch, ignition switch, and so forth.

The ECU 24 is a calculator that has a microprocessor, including a central processing unit (CPU), memory in the form of ROM (including electronically erasable and programmable ROM (EEPROM)) and random access memory (RAM), and further input output devices such as an A/D converter and D/A converter, a timer serving as a clock unit, and so forth. The ECU 24 functions as various types of function realizing units, such as for example a control unit, computing unit, processing unit, and so forth, by the CPU reading out and executing the program recorded in the ROM. The ECU 24 is not restricted to a configuration of a single ECU, and may be configured including multiple ECUs.

The ECU 24 decides the distribution (assignation) of the load which the FC 18 should bear (load power), the load which the BAT 20 should bear (load power), and the load which the regenerative power source (driving motor 14) should bear (load power), while arbitrating among these, in accordance with the load (load power) that the overall FC automobile 10 requires of the FC system 12, based on the state of the FC 18, the state of the BAT 20, the state of the driving motor 14, and further input values from the various switches and various sensors. The ECU 24 accordingly controls the driving motor 14, INV 16, air pump unit 40, external electric power supply inverter 32, FC 18, BAT 20, SUC 21, and SUDC 22. That is to say, the ECU 24 performs energy management of the overall FC automobile 10 including the FC 18, BAT 20, load 30, external electric power supply unit 34, and low-voltage components.

Further, when using the FC automobile 10 not as a vehicle but as an electric power supply system using the external electric power supply unit 34, the ECU 24 controls the FC 18, BAT 20, SUC 21, and SUDC 22, air pump unit 40, and external electric power supply unit 34, in accordance with the load (load power) that the overall electric power supply system requires of the FC system 12, based on the state of the FC 18, the state of the BAT 20, the state of the external load 35, and further input values from the various switches and various sensors. That is to say, the ECU 24 performs energy management of the overall FC system 12 including the FC 18 and BAT 20.

So far, the basic configuration of the FC automobile 10, to which the fuel cell system 12 according to the present embodiment has been applied, has been described. Next, examples of control processing carried out by the ECU 24 will be described in the order of “Basic Control”, “Low-temperature running control”, and “External Electric Power Supply Control”.

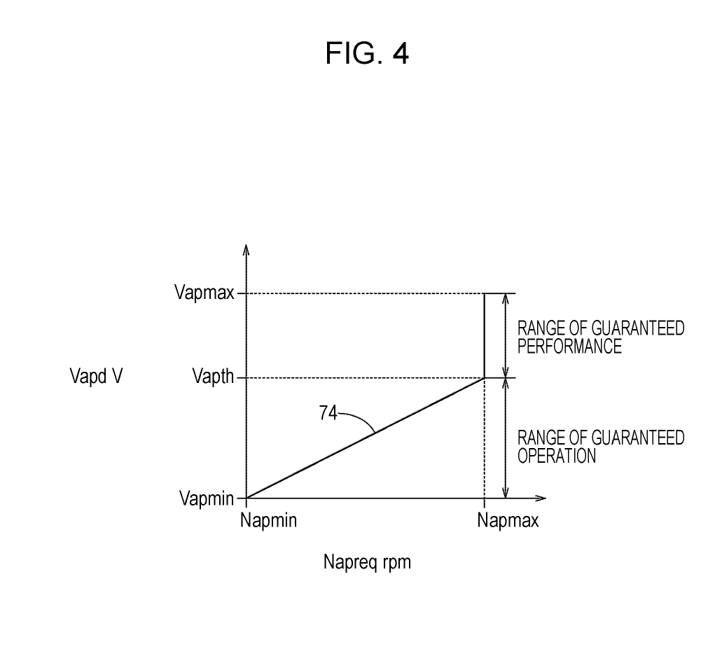

The properties of the air pump unit 40 (air pump 31) will be described first. The properties of the air pump unit 40 are the premise for the following description. FIG. 4 illustrates a property 74 representing the relationship between requested air pump revolutions Napreq (rpms) and required air pump voltage Vapd (volts (V)). The property 74 is stored in a storage device within the ECU 24, having been obtained by experimentation and simulation beforehand.

When the required air pump voltage Vapd is set within a voltage range from a threshold voltage Vapth to an upper limit air pump voltage Vapmax (Vapth≦Vapd≦Vapmax), the performance of the air pump 31 can be fully utilized in the rated range (between minimum revolutions Napmin and maximum revolutions Napmax), which is a range of guaranteed performance of the air pump unit 40. There is no restriction regarding performance in this range.

When the required air pump voltage Vapd is set within a voltage range from a threshold voltage Vapth to a lower limit air pump voltage Vapmin (Vapmin≦Vapd≦Vapth), the revolutions of the air pump 31 (air pump revolutions Nap) are restricted to the rated range (predetermined revolutions between minimum revolutions Napmin and maximum revolutions Napmax) following the property 74, which is a range of guaranteed operation of the air pump unit 40. Performance is restricted here. That is to say, the performance of the air pump 31 is restricted in the range of guaranteed operation where the required air pump voltage Vapd is a voltage at the threshold voltage Vapth or lower, to the lower limit air pump voltage Vapmin that corresponds to a minimum operation guaranteed revolutions Napmin.

If voltage exceeding the upper limit air pump voltage Vapmax is applied, the air pump unit 40 (air pump 31) will be damaged. On the other hand, if voltage lower than the lower limit air pump voltage Vapmin is applied, the air pump unit 40 (air pump 31) becomes uncontrollable.

### Description of Basic Control

The basic control of the FC system 12 according to the present embodiment, where the air pump unit 40 (air pump 31) is directly connected to the BAT 20 as illustrated in FIGS. 1 and 2, includes a required air pump voltage setting step of setting required air pump voltage Vapd that needs to be applied to the air pump inverter 23 in accordance with target FC power Pfctar, which is a power generation target for the FC 18 in accordance with the requested voltage of the load, and a electric storage device voltage setting step of setting of the BAT voltage Vbat SOC of the BAT 20 so as to satisfy the required air pump voltage Vapd set in the required air pump voltage setting step. According to this basic control, the BAT voltage Vbat is set so as to satisfy the required air pump voltage Vapd so a situation where the air pump driving voltage Vap becomes insufficient and the FC power Pfc of the FC 18 drops below the target FC power Pfctar can be prevented, due to the air pump driving voltage Vap being set to the required air pump voltage Vapd.

### Description of Low Temperature Running Control

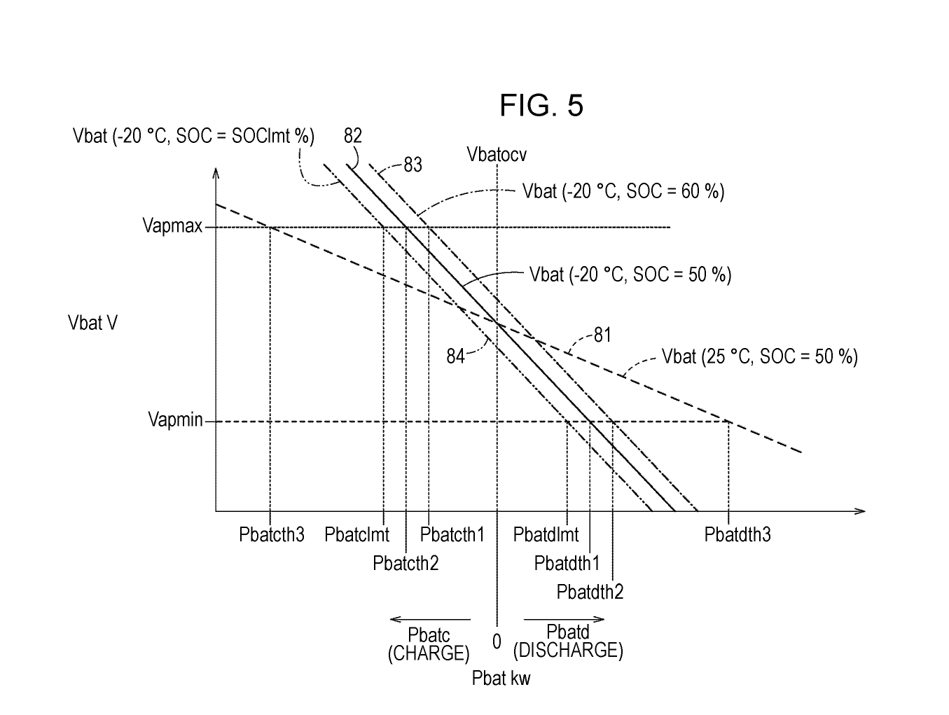

It is widely known that in a case where the BAT temperature Tb is lower than ordinary temperature, such as lower than 25° C. for example, and particularly is lower than freezing (0° C.) for example, the internal resistance rapidly increases. In this case, if the BAT temperature Tb of the BAT 20 is low, it should be noted that the BAT voltage Vbat of charging/discharging in property 82 where Tb=−20° C. (SOC=50%) may fall below the lower limit air pump voltage Vapmin even if the charging/discharging BAT power Pbat is a BAT discharge power Pbatd (also referred to as “upper limit BAT discharge power threshold value Pbatdth1”) is smaller in comparison with a upper limit BAT discharge power threshold value Pbatdth3 of a property 81 where Tb=25° C. (SOC=50%), i.e., Pbatdth1<Pbatdth3, as illustrated in FIG. 5.

It also should be noted in FIG. 5 that the upper limit air pump voltage Vapmax is exceeded even by a BAT charge/discharge power Pbatd (also referred to as “upper limit BAT charge power threshold value Pbatcth2”) smaller in comparison with the upper limit BAT charge power threshold value Pbatcth3 of a property 81 where Tb=−25° C. (SOC=50%), i.e., |Pbatcth2|<|Pbatcth3|. Further notice should be given to the point that in a case where the charging/discharging BAT power Pbat is 0 kW, the BAT voltage Vbat goes to the open-circuit voltage Vbatocv.

In light of these tendencies, the Low Temperature Running Control, where the air pump driving voltage Vap is controlled to be a voltage in the range between the upper limit air pump voltage Vapmax and lower limit air pump voltage Vapmin if the temperature is low, will be described. Description will be made in detail in accordance with two separate cases, (1) a case of handling by varying the target SOCtar of the BAT 20, and (2) a case of handling by restricting the BAT power Pbat of the BAT 20.

### (1) Case of Handling by Varying Target SOCtar of BAT 20

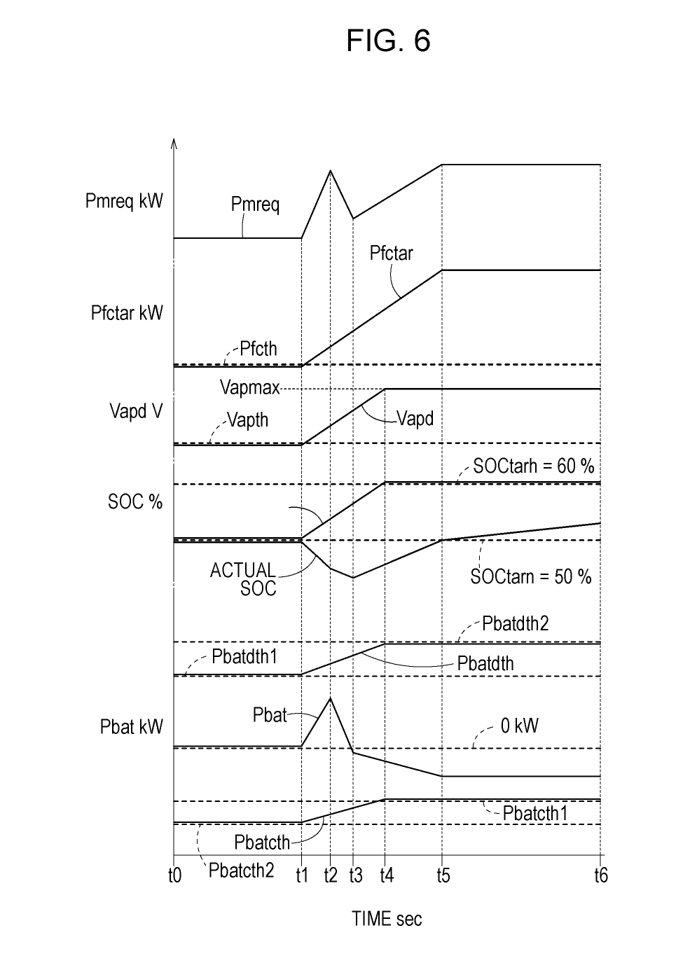

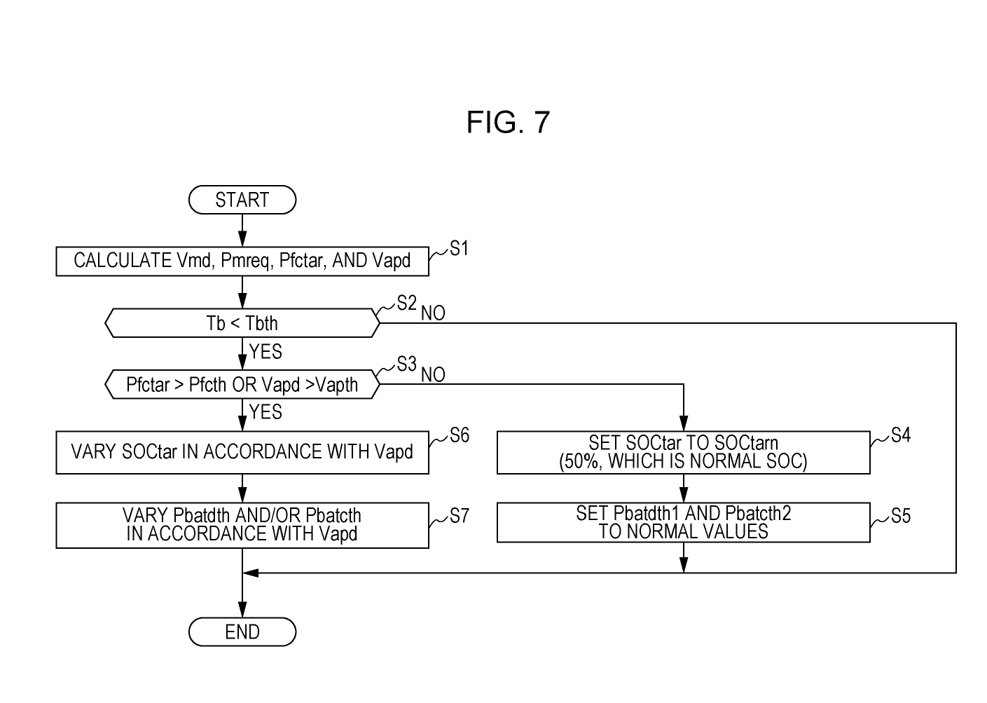

Description will be made with reference to the timing chart in FIG. 6 and the flowchart in FIG. 7. Note that the executing entity of the program according to the flowchart illustrated in FIG. 7 is the CPU of the ECU 24.

The items on the vertical axis in FIG. 6 are, in order from the top down, requested motor power Pmreq (kW), target FC power Pfctar (kW), required air pump voltage Vapd (V), target SOCtar and actual SOC of the BAT 20, and the BAT power Pbat (kW), representing how these items change over time.

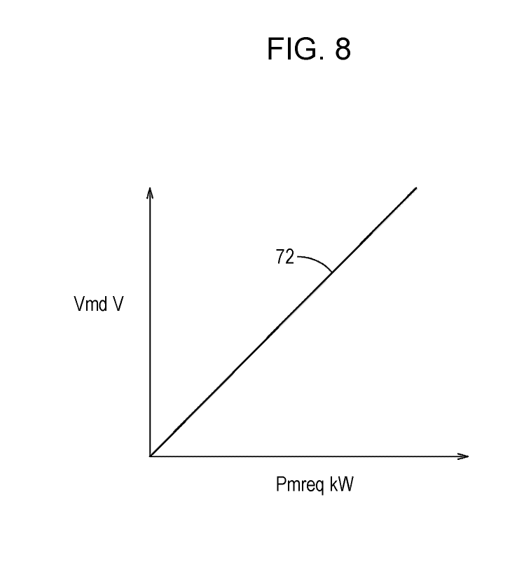

In step S1 in the flowchart in FIG. 7, the ECU 24 calculates the required motor voltage Vmd and required air pump voltage Vapd. To calculate the required motor voltage Vmd, the ECU 24 first calculates requested motor power Pmreq (kW) of the driving motor 14 by referencing a properties map (not illustrated) of required torque Treq (N·m) as to motor revolutions Nm (rpms), in accordance with the amount of pedal operation (accelerator angle) Op and vehicular speed Vs (km/h). Next, the ECU 24 references a property 72 illustrated in FIG. 8, to calculate the required motor voltage Vmd proportionate to the requested motor power Pmreq. The required motor voltage Vmd is the minimum required voltage for the secondary side voltage V2 of the SUC 21 or SUDC 22, applied to the DC end of the INV 16 to realize the requested motor power Pmreq.

To calculate the required air pump voltage Vapd, the ECU 24 calculates the requested motor power Pmreq and target FC power Pfctar for the FC 18 handling requested power for components such as air conditioning and the like that are omitted from illustration. The ECU 24 also calculates lack or excess as to the target FC power Pfctar as BAT power Pbat.

The required air pump voltage Vapd is then calculated based on the requested air pump revolutions Napreq capable of generating a target airflow (target oxidant gas flow) necessary to be supplied to the FC 18 to generate the target FC power Pfctar. In this case, the hydrogen flow basically is set corresponding to the target FC power Pfctar, and is configured so that the amount of hydrogen supplied from the hydrogen tank 37 through a regulator (omitted from illustration) increases when the hydrogen flow increases, for example. The required air pump voltage Vapd may be calculated (decided) based on target air pump power consumption or air pump torque, besides being calculated (decided) based on the requested air pump revolutions Napreq.

The required air pump voltage Vapd is calculated as the required air pump voltage Vapd corresponding to the requested air pump revolutions Napreq (rpms) with reference to the property 74 illustrated in FIG. 4. That is to say, the requested motor power Pmreq, target FC power Pfctar, and required air pump voltage Vapd, illustrated in FIG. 6, are calculated in step S1, in addition to the required motor voltage Vmd. The BAT power Pbat is controlled so as to satisfy this required air pump voltage Vapd.

Next, in step S2, determination is made whether or not the BAT temperature Tb is a lower temperature than a threshold temperature Tbth for determining that the temperature is low. The threshold temperature Tbth is set to a temperature around 5° C. or lower where the internal resistance value of the BAT 20 rises by a predetermined percentage in comparison with the internal resistance value thereof at ordinary temperature, although this depends on the performance of the BAT 20. In the present embodiment, the threshold temperature Tbth is set to 0° C., i.e., the freezing point.

In a case where the BAT temperature Tb is the threshold temperature Tbth or higher (NO in step S2), the processing of Low Temperature Running Control in the following step S3 and thereafter is not executed. However, in a case of using a BAT 20 that has a relatively small BAT power Pbat which is charge/discharge power, the flowchart in FIG. 7 may be applied with the temperature determination processing of step S2 omitted.

In a case where the BAT temperature Tb is lower than the threshold temperature Tbth (YES in step S2), the flow advances to step S3. The BAT temperature Tb will be assumed to be −20° C. here, to facilitate understanding. In step S3, determination is made regarding whether either one of the following determinations is positive. One is whether or not the target FC power Pfctar is larger than the threshold power Pfcth (see FIG. 6), and the other is whether or not the required air pump voltage Vapd is larger than the threshold voltage Vapth (see FIG. 6) which is a low-load determination threshold value.

In a case where both determinations are negative (NO in step S3, meaning that Pfctar Pfcth and Vapd Vapth), in step S4 the target SOCtar of the BAT 20 is left set to SOCtarn (SOCtar=SOCtarn) which is the normal target of SOC=50%.

In this case, the upper limit BAT discharge power threshold value Pbatdth which is the upper limit threshold value of the discharge power Pbatd of the BAT 20 is set to the upper limit BAT discharge power threshold value Pbatdth1 (normal value) at the intersection between the BAT charge/discharge voltage property 82 where Tb=−20° C. (SOC=50%) and the lower limit air pump voltage Vapmin. At the same time, the upper limit BAT charging power threshold value Pbatcth which is the upper limit threshold value of the charging power Pbatc of the BAT 20 is set to the upper limit BAT discharge power threshold value Pbatdth2 (normal value) at the intersection of the BAT charge/discharge voltage property 82 and the upper limit air pump voltage Vapmax.

During a period of point-in-time t0 to point-in-time t1, the processing of step S1→YES in step S2→NO in step S3→step S4→step S5 is repeated at short control cycles of around a millisecond (msec) or so, for example. In this period of point-in-time t0 to point-in-time t1, the requested motor power Pmreq is provided by the FC power Pfc that is tracking the target FC power Pfctar so as to match it, the BAT power Pbat is kept at Pbat=0 kW, there is no change in electric power balance, and there is neither increase nor decrease in the BAT power Pbat (no charging/discharging).

Assumption will be made here that in point-in-time t1, an accelerator pedal, omitted from illustration, has been stepped down on, the accelerator angle θp has suddenly increased and the state transitions to one of rapid acceleration, whereby the determination in step S3 is positive (YES in step S3). To facilitate understanding here, both determinations of Pfctar>Pfcth and Vapd>Vapth are assumed to have gone positive (exceeded the low load determination threshold value) at the point of starting rapid acceleration which is point-in-time t1 in FIG. 6.

In this case, the target FC power Pfctar of the FC 18 does not rapidly rise in accordance with the requested motor power Pmreq, so the requested motor power Pmreq for the rapid acceleration is provided for by the BAT power Pbat, which can be seen by the wave-shaped change in BAT power Pbat from point-in-time t1 through point-in-time t3. The target FC power Pfctar of the FC 18 rises at a speed determined beforehand (predetermined sped), and the required air pump voltage Vapd is decided following this rising speed. At point-in-time t4, the required air pump voltage Vapd has reached the upper limit air pump voltage Vapmax.

In step S6, target SOCtar is changed from the SOCtarn (SOCtar=SOCtarn) which is the normal target of SOC=50%, to SOCtarh (SOCtar=SOCtarh) which is a high load requirement target of SOC=60%, in accordance with increase/decrease of the required air pump voltage Vapd (increase in this case), as indicated by the period of point-in-time t1 through point-in-time t4 in FIG. 6. In this case, the property to reference is changed from the BAT charge/discharge voltage property 82 where SOC=50% to a BAT charge/discharge voltage property 83 where SOC=60%.

At this time, the actual SOC as shown in FIG. 6 drops in the period from point-in-time t1 to point-in-time t3 since the BAT 20 is discharging, and rises in the period from point-in-time t3 through point-in-time t5 since the BAT 20 is charging in accordance with the increase in target FC power Pfctar.

In step S7, the upper limit BAT discharge power threshold value Pbatdth which is the upper limit threshold value of the discharge power Pbatd of the BAT 20, and/or the upper limit BAT charging power threshold value Pbatcth which is the upper limit threshold value of the charging power Pbatc of the BAT 20, is/are changed (increased in this case) from upper limit BAT discharge power threshold value Pbatdth1 toward upper limit BAT discharge power threshold value Pbatdth2 and also changed from BAT charge power threshold value Pbatcth2 toward upper limit BAT charge power threshold value Pbatcth1, in accordance with the increase/decrease of the required air pump voltage Vapd (increase in this case), so as to correspond to the change in the high load target SOCtarh (SOCtar=SOCtarh) of the BAT 20.

In this case, the upper limit BAT discharge power threshold value Pbatdth which is the upper limit threshold value of the discharge electric power Pbatd of the BAT 20 is obtained as the upper limit BAT discharge power threshold value Pbatdth2, which is the electric power at the intersection between the BAT charge/discharge voltage property 83 illustrated in FIG. 5 where SOC=60% at Tb=−20° C. and the lower limit air pump voltage Vapmin. The upper limit BAT charge power threshold value Pbatcth which is the upper limit threshold value of the charge electric power Pbatc of the BAT 20 is obtained as the upper limit BAT charge power threshold value Pbatcth1, which is the electric power at the intersection between the BAT charge/discharge voltage property 83 and the upper limit air pump voltage Vapmax. The required air pump voltage Vapd is fixed to the upper limit air pump voltage Vapmax from point-in-time t4 and thereafter, so output restriction of the BAT power Pbat is fixed to the upper limit BAT discharge power threshold value Pbatdth2 and upper limit BAT charge power threshold value Pbatcth1.

As described above, in the example where (1) Case of Handling by Varying Target SOCtar of BAT 20 in Low Temperature Running Control is carried out, increase in required air pump voltage Vapd serves as a trigger when the temperature is low. The target SOC tar is raised from 50% to 60%, the output restriction of the BAT power Pbat is changed from the upper limit BAT charge power threshold value Pbatcth2 to the upper limit BAT charge power threshold value Pbatcth1 in accordance with the increase/decrease of the required air pump voltage Vapd, and also the upper limit BAT discharge power threshold value Pbatdth1 is changed to the upper limit BAT discharge power threshold value Pbatdth2. Thus, the air pump driving voltage Vap which is the driving voltage of the air pump unit 40 (air pump 31) is kept from exceeding the upper limit air pump voltage Vapmax and also kept from falling below the lower limit air pump voltage Vapmin. That is to say, even if the required air pump voltage Vapd changes (increase in this case), the air pump driving voltage Vap is controlled to be within the control range between the upper limit air pump voltage Vapmax and the lower limit air pump voltage Vapmin.

### (2) Case of Handling by Restricting BAT Power Pbat of BAT 20

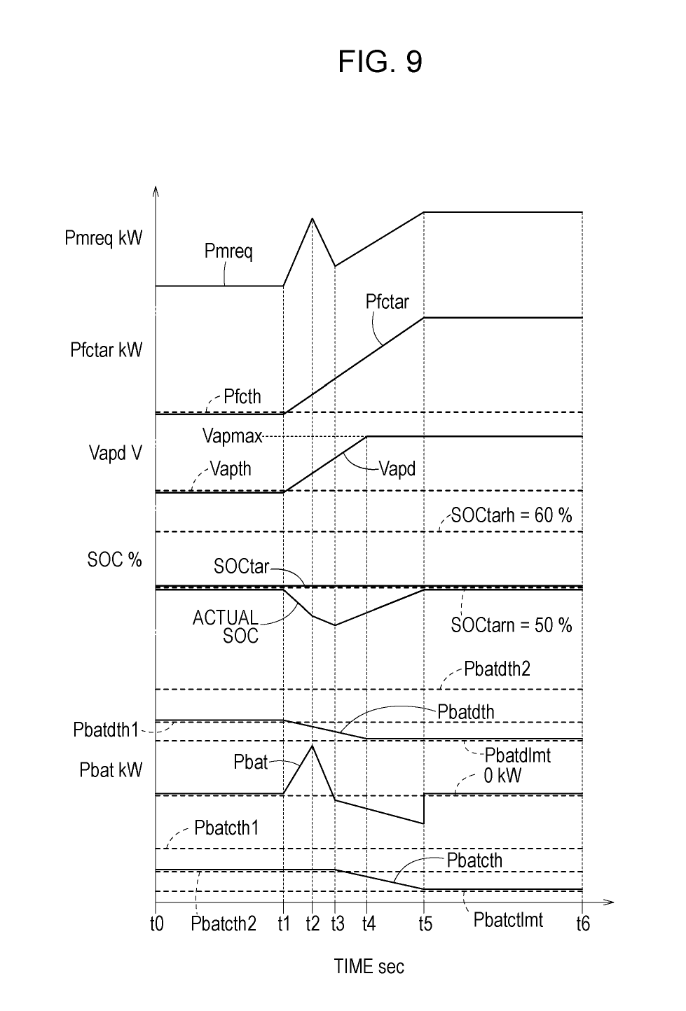

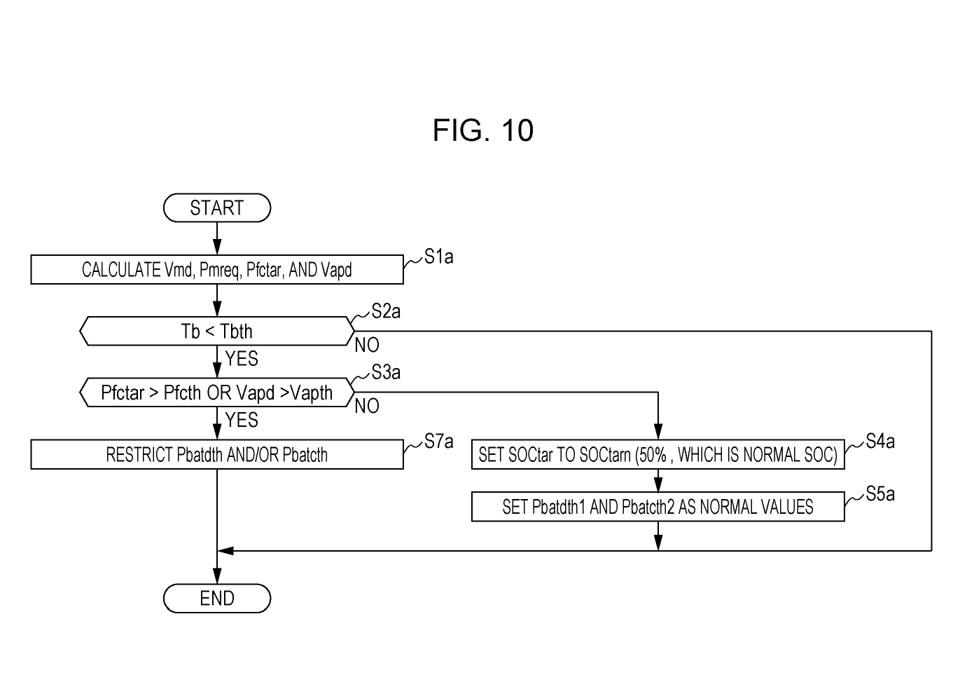

Description will be made with reference to the timing chart in FIG. 9 and the flowchart in FIG. 10. Note that the executing entity of the program according to the flowchart illustrated in FIG. 10 is the CPU of the ECU 24.

The items on the vertical axis in FIG. 9 are, in order from the top down, requested motor power Pmreq (kW), target FC power Pfctar (kW), required air pump voltage Vapd (V), target SOCtar and actual SOC of the BAT 20, and the BAT power Pbat (kW), representing how these items change over time, in the same way as in FIG. 6.

In step S1a in the flowchart in FIG. 10, the ECU 24 calculates the required motor voltage Vmd, target FC power Pfctar, and required air pump voltage Vapd, illustrated in FIG. 9, in the same way as the above-described example. The BAT power Pbat is controlled so as to satisfy this required air pump voltage Vapd.

Next, in step S2a, determination is made whether or not the BAT temperature Tb is a lower temperature than a threshold temperature Tbth for determining that the temperature is low. The threshold temperature Tbth is set to a temperature around 5° C. or lower where the internal resistance value of the BAT 20 rises by a predetermined percentage in comparison with the internal resistance value thereof at ordinary temperature, although this depends on the performance of the BAT 20. In the present embodiment, the threshold temperature Tbth is set to 0° C., i.e., the freezing point.

In a case where the BAT temperature Tb is the threshold temperature Tbth or higher (NO in step S2a), the processing of Low Temperature Running Control in the following step S3a and thereafter is not executed. However, in a case of using a BAT 20 that has a relatively small BAT power Pbat which is charge/discharge power, the flowchart in FIG. 10 may be applied with the temperature determination processing of step S2a omitted.

In a case where the BAT temperature Tb is lower than the threshold temperature Tbth (YES in step S2a), the flow advances to step S3a. The BAT temperature Tb will be assumed to be −20° C. here, to facilitate understanding. In step S3a, determination is made regarding whether either one of the following determinations is positive. One is whether or not the target FC power Pfctar is larger than the threshold power Pfcth (see FIG. 9), and the other is whether or not the required air pump voltage Vapd is larger than the threshold voltage Vapth (see FIG. 9) which is a low-load determination threshold value.

In a case where both determinations are negative (NO in step S3a, meaning that Pfctar≦Pfcth and Vapd≦Vapth), in step S4a the target SOCtar of the BAT 20 is left set to SOCtarn (SOCtar=SOCtarn) which is the normal target of SOC=50%.

In this case, the upper limit BAT discharge power threshold value Pbatdth which is the upper limit threshold value of the discharge power Pbatd of the BAT 20 is set to the upper limit BAT discharge power threshold value Pbatdth1 (normal value) at the intersection between the BAT charge/discharge voltage property 82 where Tb=−20° C. (SOC=50%) and the lower limit air pump voltage Vapmin. At the same time, the upper limit BAT charging power threshold value Pbatcth which is the upper limit threshold value of the charging power Pbatc of the BAT 20 is set to the upper limit BAT discharge power threshold value Pbatcth2 (normal value) at the intersection of the BAT charge/discharge voltage property 82 and the upper limit air pump voltage Vapmax.

During a period of point-in-time t0 to point-in-time t1, the processing of step S1a→YES in step S2a→NO in step S3a→step S4a→step S5a is repeated. In this period of point-in-time t0 to point-in-time t1, the requested motor power Pmreq is provided by the FC power Pfc that is tracking the target FC power Pfctar so as to match it, the BAT power Pbat is kept at Pbat=0 kW, there is no change in electric power balance, and there is neither increase nor decrease in the BAT power Pbat (no charging/discharging).

Assumption will be made here that in point-in-time t1, an accelerator pedal, omitted from illustration, has been stepped down on, the accelerator angle θp has suddenly increased and the state transitions to one of rapid acceleration, whereby the determination in step S3a is positive (YES in step S3a). To facilitate understanding here, both determinations of Pfctar>Pfcth and Vapd>Vapth are assumed to have gone positive (exceeded the low load determination threshold value) at the point of starting rapid acceleration which is point-in-time t1 in FIG. 9.

In this case, the target FC power Pfctar of the FC 18 does not rapidly rise in accordance with the requested motor power Pmreq, so the requested motor power Pmreq for the rapid acceleration is provided for by the BAT power Pbat, which can be seen by the wave-shaped change in BAT power Pbat from point-in-time t1 through point-in-time t3. The target FC power Pfctar of the FC 18 rises at a speed determined beforehand (predetermined sped), and the required air pump voltage Vapd is decided following this rising speed. At point-in-time t4, the required air pump voltage Vapd has reached the upper limit air pump voltage Vapmax.

At this time, the actual SOC in FIG. 6 drops during the period from point-in-time t1 through point-in-time t3, since the BAT 20 is in a discharging state, and rises during the period from point-in-time t3 through point-in-time t5, since the BAT 20 is in a charging state.

In step S7a, the upper limit BAT discharge power threshold value Pbatdth is restricted from the upper limit BAT discharge power threshold value Pbatdth1 to an even smaller upper limit BAT discharge power threshold value Pbatdth1mt, to avoid the actual SOC of the BAT 20 from falling too far (the BAT voltage Vbat from falling too far) in a case where the required air pump voltage Vapd increases or decreases (increase in this case), as shown in the period from point-in-time t1 through t4. Restricting the upper limit BAT discharge power threshold value Pbatdth to the upper limit BAT discharge power threshold value Pbatdth1mt controls the SOC of the BAT 20 so as not to fall below the value of SOC=SOC1mt, which is around SOC=40%, for example. The BAT discharge voltage Vbatd is also controlled so as to not fall below a voltage corresponding to SOC1mt. Note that in this case, the restriction of the BAT charging power threshold value Pbatcth may be lightened to the upper limit BAT charge power threshold value Pbatc1mt, which makes charging more possible.

Even if the required air pump voltage Vapd is fixed to the upper limit air pump voltage Vapmax from point-in-time t4 and thereafter, the output of the BAT power Pbat remains restricted to the upper limit BAT discharge power threshold value Pbatd1mt. Note that the upper limit BAT discharge power threshold value Pbatd1mt is maintained.

As described above, in the example where (2) Case of Handling by Restricting BAT Power Pbat of BAT 20 in Low Temperature Running Control is carried out, even if there is increase in required air pump voltage Vapd when the temperature is low, the output of the BAT power Pbat is restricted to the upper limit BAT charge power threshold value Pbatc1mt, and also the restriction is lightened to the upper limit BAT discharge power threshold value Pbatd1mt. Accordingly, the air pump driving voltage Vap which is the driving voltage of the air pump unit 40 (air pump 31) is kept from exceeding the upper limit air pump voltage Vapmax and also kept from falling below the lower limit air pump voltage Vapmin. That is to say, even if the required air pump voltage Vapd changes (increase in this case), the air pump driving voltage Vap is controlled to be within the control range between the upper limit air pump voltage Vapmax and the lower limit air pump voltage Vapmin.

### Description of External Electric Power Supply Control

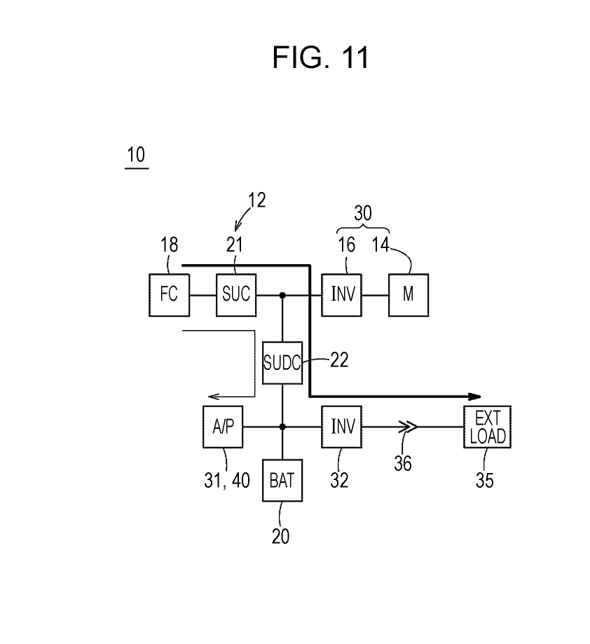

FIG. 11 is a conceptual diagram illustrating the operating state of the FC automobile 10 during external electric power supply. At the time of external electric power supply, the requested motor power Pmreq relating to the load 30 including the driving motor 14 is set to zero (0 kW). The FC power Pfc generated at the FC 18 is supplied to the external load 35 via the external electric power supply inverter 32, through the SUC 21 and SUDC 22, and also is supplied to the air pump unit 40 (air pump 31).

During external electric power supply, control is effected so that there basically is no charging/discharging of the BAT 20. However, the BAT voltage Vbat directly serves as the air pump driving voltage Vap and the external electric power supply voltage Vext, so electric power supply is performed to the external load 35 from the BAT 20 as well, and FC power Pfc is charged to the BAT 20, while adjusting the BAT voltage Vbat to an optimal level. This control enables electric power supply that is both efficient and thermally stable (conforming to thermal restrictions).

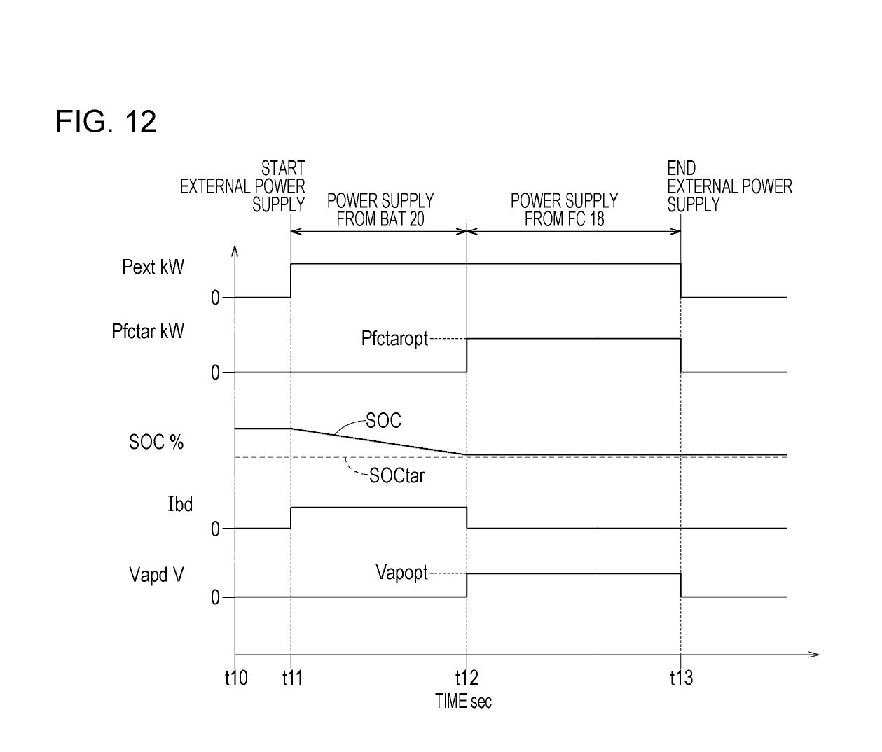

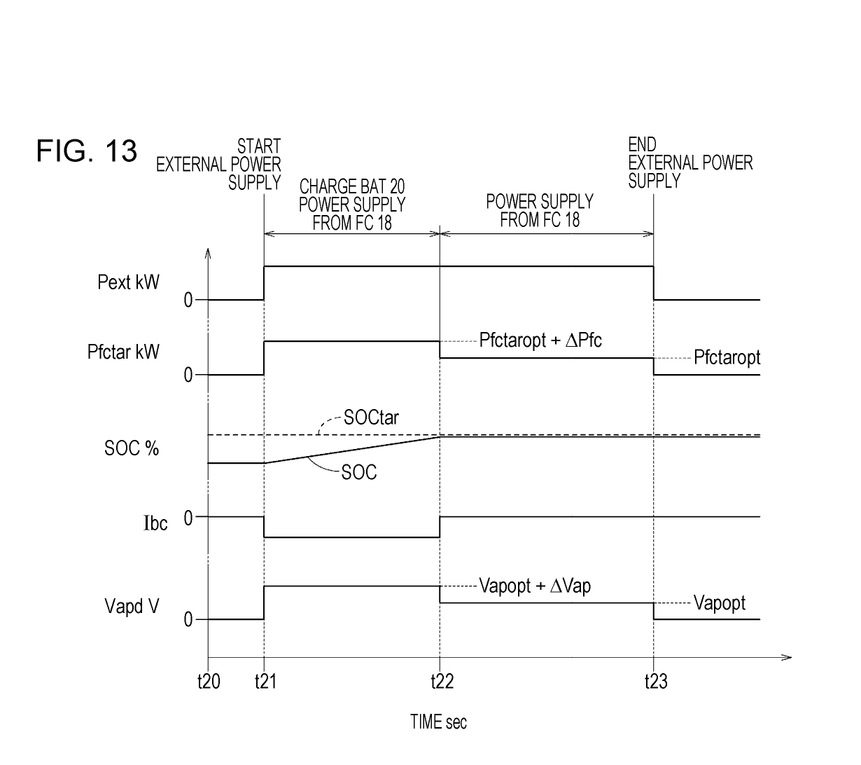

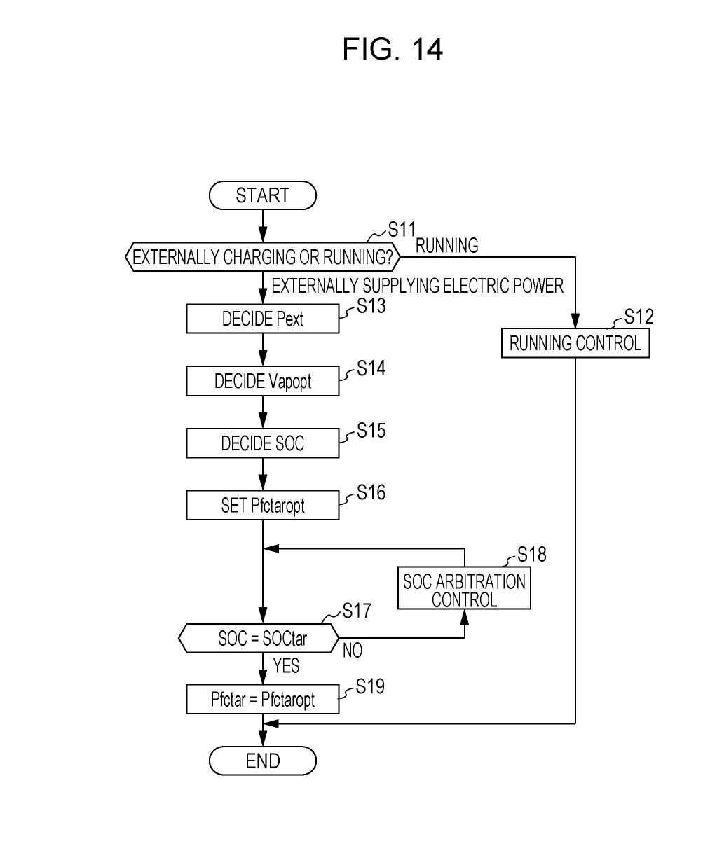

External Electric Power Supply Control will be described in detail with reference to the timing charts in FIGS. 12 and 13, and the flowchart in FIG. 14. In step S11, determination is made regarding whether or not the vehicle 10 is in an external electric power supply state or a running state, by whether the external electric power supply switch 33 is on or off. In a case where the external electric power supply switch 33 is off, and an ignition switch omitted from illustration is on, the vehicle 10 is running (RUNNING in step S11). Accordingly, the low temperature running control described with reference to the flowchart in FIG. 7 (represented by step S12 in the flowchart in FIG. 14) and so forth is performed.

On the other hand, in a case where the external electric power supply switch 33 is in an on state and external electric power supply is being performed (EXTERNALLY SUPPLYING ELECTRIC POWER in step S11), in step S13 an external supply electric power Pext is decided. The is decided by command from an unshown operating panel within the FC automobile 10, or by request from the external load 35, for example. An example will be described here where the external supply electric power Pext has been decided to be Pext=5 kW.

Next, in step S14, an optimal air pump voltage Vapopt, where the efficiency is highest with regard to the external supply electric power Pext, is decided. In this case, an efficiency property 91 of the external electric power supply inverter 32 with regard to the required air pump voltage Vapd when the FC power Pfc is Pfc=Pext=5 kW, has been stored in a storage device beforehand. The stored efficiency property 91 and an efficiency property 92 of the air pump unit 40 (air pump 31) are taken into consideration (combined) to yield an efficiency property 93. The required air pump voltage Vapd on the efficiency property 93 where the efficiency η% is the largest is decided to be the optimal air pump voltage Vapopt. Hereinafter, the required air pump voltage Vapd that follows the air pump efficiency property 92 will be referred to as “requested air pump efficiency voltage Vapη”, the external inverter voltage Vextinv that follows the external electric power supply efficiency property 91 as “requested external inverter efficiency voltage Vextinvη”, and the BAT voltage Vbat (required air pump voltage Vapd) that follows the efficiency property 93 as “requested primary side efficiency voltage V1η”.

Next, in step 15, a SOC is decided for the BAT 20 to yield the optimal air pump voltage Vapopt. In this case, BAT voltage Vbat properties 101 through 103 are referenced using as a parameter the SOC value corresponding to the BAT power Pbat that is charging/discharging electric power, obtained and stored in the storage device beforehand. The SOC having the property 103 (Pbat=0 kW) that passes through the intersection between the straight line of the optimal air pump voltage Vapopt and the open-circuit voltage Vbatocv is set to the target SOCtar=35%. A property between other properties may be obtained by interpolation processing.

Next, in step S16, a target FC power (optimal target PC power) Pfctaropt where the FC power Pfc is the target SOCtar of the BAT 20 (where Vapd=Vapopt=Vbat) is decided.

Determination is then made in step S17 whether or not the SOC of the BAT 20 is the target SOCtar, and if not (NO in step S17), SOC arbitration control is performed in step S18 so that the SOC is controlled to the target SOCtar.

In a case where the SOC of the BAT 20 is or has been the target SOCtar, in which case (YES in step S17), the target FC power Pfctar is fixed to the target FC power Pfctaropt and power in step S19 is supplied to the external load 35.

Description will be made by the timing chart in FIG. 12 concerning a case where the SOC of the BAT 20 was higher than the target SOCtar (SOC>SOCtar) at the time of starting external electric power supply, regarding the processing of NO in step S17→step S18→YES in step S17→step S19.

In a case where starting of external electric power supply has been detected at point-in-time t11, external supply electric power Pext is supplied from the BAT 20 alone (Vapd=0 V, Pfctar=0 kW) during the period of point-in-time t11 through point-in-time t12 (YES in step S17), since the SOC of the BAT 20 has been higher than the SOCtar. In a case where the SOC of the BAT 20 is the target SOCtar at point-in-time t12 (YES in step S17), thereafter the required air pump voltage Vapd is set to the optimal air pump voltage Vapopt and the target FC power Pfctar is set to the target FC power Pfctaropt, and electric power supply is performed from the FC 18 alone to point-in-time t13, which is the end of external electric power supply.

Next, description will be made by the timing chart in FIG. 13 concerning a case where the SOC of the BAT 20 was lower than the target SOCtar (SOC<SOCtar) at the time of starting external electric power supply, regarding the processing of NO in step S17→step S18→YES in step S17→step S19.

In a case where starting of external electric power supply has been detected at point-in-time t21, an amount of target FC power Pfctar corresponding to the charging current Ibc of the BAT 20 (minute FC power ΔPfc) is added to the target FC power Pfctaropt at point-in-time t21, and the FC 18 generates electricity, since the SOC of the BAT 20 has been lower than the SOCtar. Accordingly, in the following point-in-time t21 through point-in-time t22, the BAT 20 is charged and external supply electric power Pext is supplied from the FC 18. The required air pump voltage Vapd is set to a required air pump voltage Vapd to which a minute required air pump voltage ΔVapd necessary to generate the target FC power Pfctar (Pfctar=Pfctaropt+ΔPfc) has been added (Vapd=Vapopt+ΔVapd).

At point-in-time t22, in a case where the SOC of the BAT 20 is the target SOCtar (YES in step S17, thereafter the required air pump voltage Vapd is set to the optimal air pump voltage Vapopt and the target FC power Pfctar is set to the target FC power Pfctaropt, and electric power supply is performed from the FC 18 alone to point-in-time t23, which is the end of external electric power supply. Note that the SOC arbitration control processing in step S18 is primarily executed in the period of point-in-time t11 to point-in-time t12 in FIG. 12 and in the period of point-in-time t21 to point-in-time t22 in FIG. 13.

### Conclusion of Embodiment, and Modifications

The embodiment described above relates to energy management control in the FC system 12 that has the two voltage transducers of SUC 21 and SUDC 22, where the air pump 31 is disposed at the BAT 20 side, the BAT 20 being disposed on the primary side 1sb of the SUDC 22. In a case where the air pump unit 40 including the air pump 31 is disposed at the primary side 1sb, the BAT voltage Vbat and the air pump driving voltage Vap become equal. Accordingly, the BAT voltage Vbat is adjusted to be a voltage equal to or greater than the required air pump voltage Vapd that is determined by the target FC power Pfctar corresponding to the requested FC load power, in such an FC system 12. When performing external electric power supply, required air pump voltage Vapd satisfying the requested FC load power is first secured, whereupon the external electric power supply is carried out having adjusted the BAT voltage Vbat to be a required air pump voltage Vapd taking the requested air pump efficiency voltage Vapη into consideration. This control enables required air pump voltage Vapd to be secured during normal generation (when running), so insufficient power performance can be prevented, and on the other hand external electric power supply can be performed at maximal efficiency.

In further detail, the FC system 12 according to the above-described embodiment includes the FC 18 that generates electricity by causing reaction of oxidant gas and hydrogen, and outputs the FC voltage Vfc, the BAT 20 that outputs BAT voltage Vbat, the load 30 made up of the inverter 16 and the driving motor 14 driven by the inverter 16, the SUC 21 serving as a first voltage transducer that performs voltage conversion (boosting) of the FC voltage Vfc of the FC 18 and applies as secondary side voltage V2 to the DC end side of the inverter 16 as required motor voltage Vmd, the SUDC 22 serving as a second voltage transducer that performs voltage conversion (boosting) of the BAT voltage Vbat of the BAT 20 and applies as secondary side voltage V2 to the DC end side of the inverter 16 as required motor voltage Vmd, and the air pump 31 that is driven through the air pump inverter 23 and air pump motor 29 together making up the air pump driving unit. The air pump 31 supplies the oxidant gas to the FC 18 upon being driven through the air pump driving unit to which the primary side voltage V1 is applied.

The control method of the FC system 12 includes: a required air pump voltage setting step of setting the required air pump voltage Vapd, regarding which application to the air pump inverter 23 is required in accordance with the target FC power Pfctar of the FC 18; and an electric storage device voltage setting step of setting the BAT voltage Vbat, so as to satisfy the required air pump voltage Vapd.

The BAT voltage Vbat is set to satisfy the required air pump voltage Vapd, thereby preventing a situation in which the air pump driving voltage Vap is insufficient and the FC power Pfc of the FC 18 drops below the target FC power Pfctar.

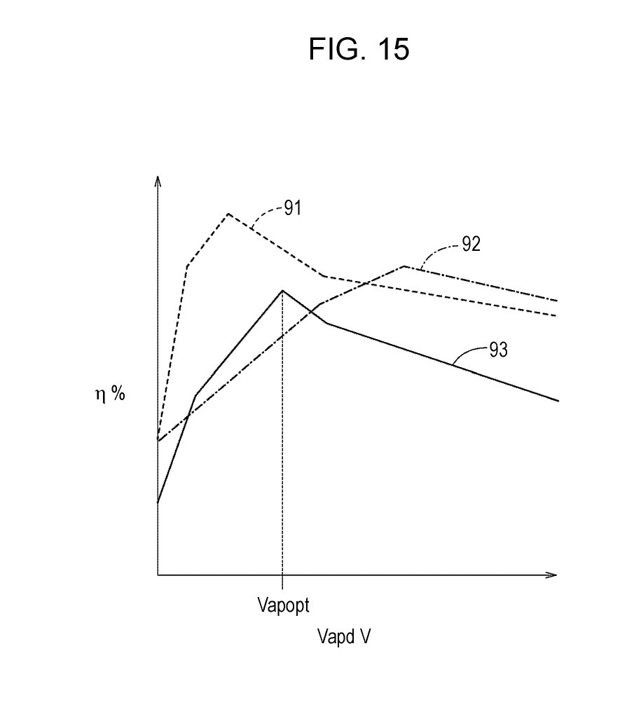

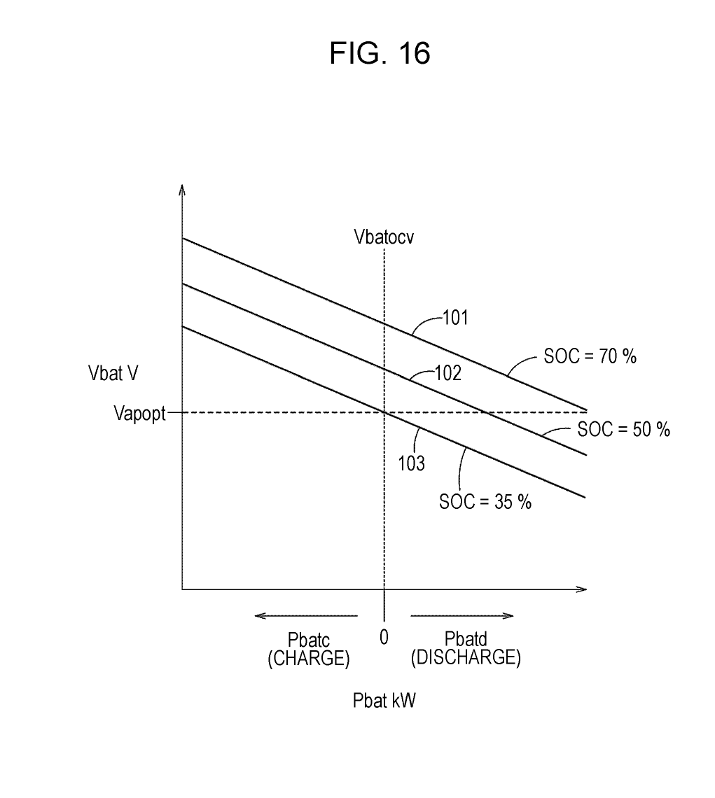

The FC system 12 includes the external electric power supply inverter 32 to which is applied the primary side voltage V1 as external inverter voltage Vextinv serving as external load driving voltage, and the external load 35 driven through the external electric power supply inverter 32. In this case, the method includes: an external electric power supply necessity determining step (step S11) of determining whether or not external electric power supply is to be performed; an air pump driving amount setting step (step S14) of setting an air pump driving amount capable of generating the target FC power Pfctar of the FC 18 in accordance with external supply electric power Pext that has been set, in a case where determination has been made to perform external electric power supply; a requested air pump efficiency voltage calculating step (step S14) of calculating the requested air pump efficiency voltage Vapη based on the set air pump driving amount (calculated by referencing property 92 in FIG. 15); a requested inverter efficiency voltage calculating step (step S14) of calculating a requested inverter efficiency voltage for external electric power supply Vextinvη, based on the external supply electric power Pext that has been set (calculated by referencing property 91 in FIG. 15); an external electric power supply requested primary side efficiency voltage setting step (step S14) of setting optimal air pump voltage Vapopt as requested primary side efficiency voltage V1η, based on the requested air pump efficiency voltage Vapη and requested inverter efficiency voltage for external electric power supply Vextinvη (set by referencing property 93 in FIG. 15); and an electric storage device voltage adjusting step of adjusting the BAT voltage Vbat so that the BAT voltage Vbat is equal to the optimal air pump voltage Vapopt which is the requested primary side efficiency voltage V1η (NO in step S17→step S18, YES in step S17→step S19).

According to this configuration, during external electric power supply, the BAT voltage Vbat is adjusted (adjusted so that the SOC is the target SOCtar) so that the BAT voltage Vbat is equal to the requested primary side efficiency voltage V1η (optimal air pump voltage Vapopt) set based on the requested air pump efficiency voltage Vapη (required air pump voltage Vapd following property 92, equal to Vbat) and requested inverter efficiency voltage for external electric power supply Vextinvη (external inverter voltage Vextinv following property 91, equal to Vbat), so efficient external electric power supply can be performed.

### First Modification

According to a first modification, an idle generation determining step is provided to the determination of step S11 described above, to determine whether or not a target generated electric power Pfctar of the FC 18 is at or below a predetermined value (e.g., electric power around the external supply electric power Pext) where estimation is made of being in an idle generation state, in a case of the fuel cell automobile 10 idling due to being stopped at an intersection or the like, in a state of having been determined to be running and running control is being performed (Step S12). Determination of idling is made by the ignition switch being on and the vehicular speed Vs being approximately 0 km/h, or the like. Further provided are a requested air pump efficiency voltage calculating step (step S14), in which, in a case where the idle generation state has been determined in the idle generation determining step, the requested air pump efficiency voltage Vapη for effective generation of the target FC power Pfctar of the FC 18, in accordance with electric power when idle, from the air pump efficiency property 92 illustrated in FIG. 15; and an electric storage device voltage adjusting step (Step S16 through step S19) of adjusting the BAT voltage Vbat so as to be equal to the requested air pump efficiency voltage Vapη. These steps are the same processing as that described in step S14 through step S19. Thus, an efficient idling generating state can be maintained.

### Second Modification

According to a second modification, a control method of the external electric power supply unit 34 in the FC system 12 is provided. The FC system 12 the FC 18 that generates electricity by causing reaction of oxidant gas and hydrogen, and outputs the FC voltage Vfc, the BAT 20 that outputs BAT voltage Vbat, the load 30 made up of the inverter 16 and the driving motor 14 driven by the inverter 16, the SUC 21 serving as a first voltage transducer that performs voltage conversion (boosting) of the FC voltage Vfc of the FC 18 and applies as secondary side voltage V2 to the DC end side of the inverter 16 as required motor voltage Vmd, the SUDC 22 serving as a second voltage transducer that performs voltage conversion (boosting) of the BAT voltage Vbat of the BAT 20 and applies as secondary side voltage V2 to the DC end side of the inverter 16 as required motor voltage Vmd, the air pump 31 that is driven through the air pump inverter 23 and air pump motor 29 together making up the air pump driving unit, the external electric power supply inverter 32 to which is applied the primary side voltage V1 as external inverter voltage Vextinv serving as external load driving voltage, and the external load 35 driven through the external electric power supply inverter 32. The air pump 31 supplies the oxidant gas to the FC 18 upon being driven through the air pump driving unit to which the primary side voltage V1 is applied.

The control method of the external electric power supply unit 34 in the FC system 12 according to the second modification includes: an external electric power supply necessity determining step (step S11) of determining whether or not external electric power supply is to be performed; an air pump driving amount setting step (step S14) of setting an air pump driving amount capable of generating the target FC power Pfctar of the FC 18 in accordance with external supply electric power Pext that has been set, in a case where determination has been made to perform external electric power supply; a requested air pump efficiency voltage calculating step (step S14) of calculating the requested air pump efficiency voltage Vapη based on the set air pump driving amount (calculated by referencing property 91 in FIG. 15); a requested inverter efficiency voltage calculating step (step S14) of calculating a requested inverter efficiency voltage for external electric power supply Vextinvη, based on the external supply electric power Pext that has been set (calculated by referencing property 93 in FIG. 15); an external electric power supply requested primary side efficiency voltage setting step (step S14) of setting optimal air pump voltage Vapopt as requested primary side efficiency voltage V1η, based on the requested air pump efficiency voltage Vapη and requested inverter efficiency voltage for external electric power supply Vextinvη (calculated by referencing property 93 in FIG. 15); and an electric storage device voltage adjusting step of adjusting the BAT voltage Vbat so that the BAT voltage Vbat is equal to the optimal air pump voltage Vapopt which is the requested primary side efficiency voltage V1η (NO in step S17→step S18, YES in step S17→step S19).

According to this configuration, during external electric power supply, the BAT voltage Vbat is adjusted (adjusted so that the SOC is the target SOCtar) so that the BAT voltage Vbat is equal to the requested primary side efficiency voltage V1η (optimal air pump voltage Vapopt) set based on the requested air pump efficiency voltage Vapη (required air pump voltage Vapd following property 92, equal to Vbat) and requested inverter efficiency voltage for external electric power supply Vextinvη (external inverter voltage Vextinv following property 91, equal to Vbat), so efficient external electric power supply can be performed. Note that the SUC 21 serving as the first voltage transducer may be omitted from the second modification as well.

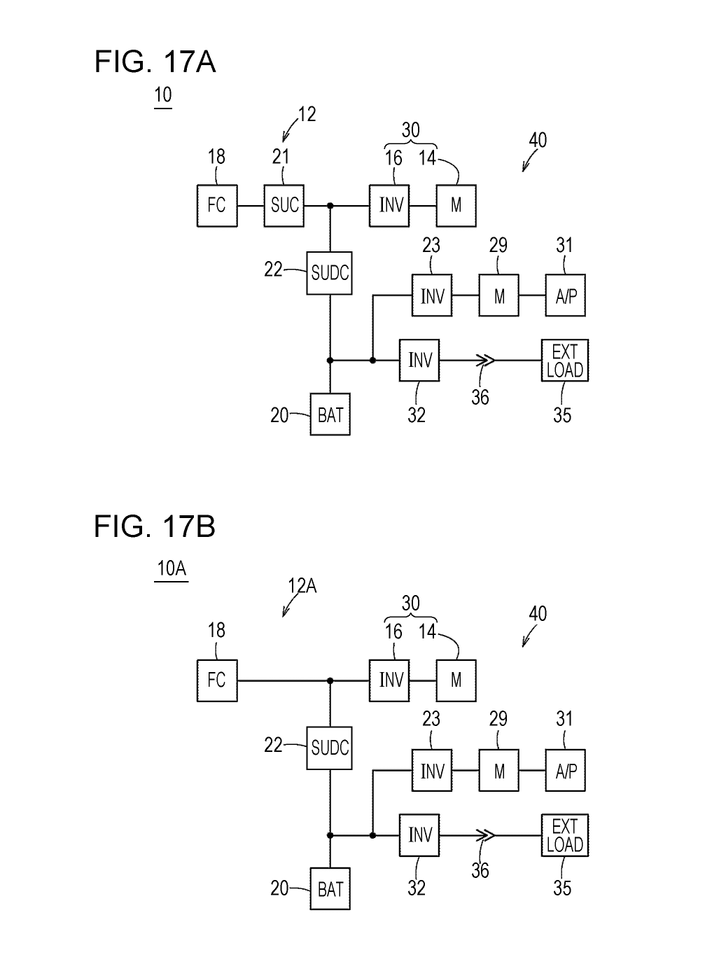

The present disclosure is not restricted to being applied to the FC automobile 10 having the FC system 12 according to above-described embodiment, illustrated in the conceptual diagram in FIG. 17A. It is needless to say that various configurations may be made, such as application to an FC automobile 10A having an FC system 12A from which the SUC 21 has been omitted, such as illustrated in the conceptual diagram in FIG. 17B.

According to a first aspect of the present disclosure, a control method of a fuel cell system is provided. The fuel cell system includes a fuel cell that generates electricity by causing reaction of an oxidant gas and a fuel gas, and outputs a fuel cell voltage, a electric storage device that outputs electric storage device voltage, a motor that is driven by a motor driving unit, a voltage transducer that converts voltage between the electric storage device voltage serving as a primary side voltage and motor driving voltage serving to a secondary side voltage that is applied to the motor driving unit, an air pump that is driving through an air pump driving unit, and an external electric power supply system having an external electric power supply inverter to which the primary side voltage is applied as external load driving voltage and an external load driven through the external electric power supply inverter. The air pump supplies the oxidant gas to the fuel cell upon being driven through the air pump driving unit to which the primary side voltage is applied. The method includes: a required air pump voltage setting step of setting a required air pump voltage, regarding which application to the air pump driving unit is required; and a electric storage device voltage setting step of setting the electric storage device voltage, so as to satisfy the required air pump voltage.

According to the configuration described above, the electric storage device voltage is set to satisfy the required air pump voltage, thereby preventing a situation in which the air pump driving voltage is insufficient and the generated electric power of the fuel cell drops below the target generated electric power.

The control method of a fuel cell system may further include: an external electric power supply necessity determining step of determining whether or not external electric power supply is to be performed; an air pump driving amount setting step of setting an air pump driving amount capable of generating a target generated electric power of the fuel cell in accordance with external supply electric power that has been set, in a case where determination has been made to perform external electric power supply; a requested air pump efficiency voltage calculating step of calculating a requested air pump efficiency voltage based on the set air pump driving amount; a requested inverter efficiency voltage calculating step of calculating a requested inverter efficiency voltage for external electric power supply, based on the set external supply electric power; an external electric power supply requested primary side efficiency voltage setting step of setting a requested primary side efficiency voltage, based on the requested air pump efficiency voltage and requested inverter efficiency voltage for external electric power supply; and an electric storage device voltage adjusting step of adjusting the electric storage device voltage so that the electric storage device voltage is equal to the requested primary side efficiency voltage.

According to this configuration, during external electric power supply, the electric storage device voltage is adjusted so that the electric storage device voltage is equal to the requested primary side efficiency voltage set based on the requested air pump efficiency voltage and requested inverter efficiency voltage for external electric power supply, so efficient external electric power supply can be performed.

The control method of a fuel cell system may further include: an idle generation determining step of determining whether or not a target generated electric power of the fuel cell is at or below a predetermined value where estimation is made of being in an idle generation state; a requested air pump efficiency voltage calculating step of calculating, in a case of having been estimated to be in the idle generation state, a requested air pump efficiency voltage for effective generation of the target generated electric power of the fuel cell, in accordance with electric power when idle; and an electric storage device voltage adjusting step of adjusting the electric storage device voltage so as to be equal to the requested air pump efficiency voltage.

According to this configuration, when idling, a requested air pump efficiency voltage for effective generation of the target generated electric power of the fuel cell is calculated in accordance with electric power when idle, and the electric storage device voltage is adjusted so as to be equal to the requested air pump efficiency voltage, so an efficient idling generating state can be maintained.

In the control method of an external electric power supply device of a fuel cell system, the fuel cell system may includes a fuel cell that generates electricity by causing reaction of an oxidant gas and hydrogen, and outputs a fuel cell voltage, a electric storage device that outputs electric storage device voltage, a motor that is driven by a motor driving unit, a voltage transducer that converts voltage between the electric storage device voltage serving as a primary side voltage and motor driving voltage serving to a secondary side voltage that is applied to the motor driving unit, an air pump that is driving through an air pump driving unit, and an external electric power supply system having an external electric power supply inverter to which the primary side voltage is applied as external load driving voltage and an external load driven through the external electric power supply inverter. The air pump supplies the oxidant gas to the fuel cell upon being driven through the air pump driving unit to which the primary side voltage is applied. The method may include: an external electric power supply necessity determining step of determining whether or not external electric power supply is to be performed; an air pump driving amount setting step of setting an air pump driving amount capable of generating a target generated electric power of the fuel cell in accordance with external supply electric power that has been set, in a case where determination has been made to perform external electric power supply; a requested air pump efficiency voltage calculating step of calculating a requested air pump efficiency voltage based on the set air pump driving amount; a requested inverter efficiency voltage calculating step of calculating a requested inverter efficiency voltage for external electric power supply, based on the set external supply electric power; an external electric power supply requested primary side efficiency voltage setting step of setting a requested primary side efficiency voltage, based on the requested air pump efficiency voltage and requested inverter efficiency voltage for external electric power supply; and an electric storage device voltage adjusting step of adjusting the electric storage device voltage so that the electric storage device voltage is equal to the requested primary side efficiency voltage.

According to this configuration, during external electric power supply, the electric storage device voltage is adjusted so that the electric storage device voltage is equal to the requested primary side efficiency voltage set based on the requested air pump efficiency voltage and requested inverter efficiency voltage for external electric power supply, so efficient external electric power supply can be performed.

Each of the above-described configurations can be suitably carried out in a fuel cell automobile.

Obviously, numerous modifications and variations of the present invention are possible in light of the above teachings. It is therefore to be understood that within the scope of the appended claims, the invention may be practiced otherwise than as specifically described herein.

What is claimed is:

1. A control method of a fuel cell system, comprising:
generating electricity in a fuel cell through reaction of an oxidant gas and a fuel gas so as to output a fuel cell voltage;
outputting an electric storage device voltage from an electric storage device;
converting from the electric storage device voltage to a motor driving voltage or from the motor driving voltage to the electric storage device voltage, the electric storage device voltage serving as a primary side voltage, the motor driving voltage serving as a secondary side voltage and being to be applied to a motor driving device to drive a motor;
applying the primary side voltage to an air pump driving device to drive an air pump so as to supply the oxidant gas to the fuel cell;
setting a required air pump voltage to apply to the air pump driving device; and
setting the electric storage device voltage so as to satisfy the required air pump voltage.

2. A fuel cell system comprising:
a fuel cell to generate electricity through reaction of an oxidant gas and a fuel gas so as to output a fuel cell voltage;
an electric storage device to output an electric storage device voltage;
a motor to be driven through a motor driving device;
a voltage transducer to convert from the electric storage device voltage to a motor driving voltage or from the motor driving voltage to the electric storage device voltage, the electric storage device voltage serving as a primary side voltage, the motor driving voltage serving as a secondary side voltage and being to be applied to the motor driving device;
an air pump to be driven through an air pump driving device so as to supply the oxidant gas to the fuel cell, the primary side voltage being to be applied to the air pump driving device; and
a controller configured to set a required air pump voltage to apply to the air pump driving device and configured to set the electric storage device voltage so as to satisfy the required air pump voltage.

3. The control method according to claim 1, further comprising:
applying the primary side voltage as an external load driving voltage to an external electric power supply inverter to drive an external load;
determining whether or not external electric power supply is to be performed;
setting an air pump driving amount so that the fuel cell generates a target generated electric power of the fuel cell in accordance with external supply electric power that has been set, in a case where determination has been made to perform the external electric power supply;
calculating a requested air pump efficiency voltage based on the air pump driving amount;
calculating a requested inverter efficiency voltage for external electric power supply based on the external supply electric power;
setting a requested primary side efficiency voltage based on the requested air pump efficiency voltage and the requested inverter efficiency voltage for external electric power supply; and
adjusting the electric storage device voltage so that the electric storage device voltage is equal to the requested primary side efficiency voltage.

4. The control method according to claim 1, further comprising:
determining whether or not a target generated electric power of the fuel cell is at or below a predetermined value where estimation is made of being in an idle generation state;
calculating, in a case of having been estimated to be in the idle generation state, a requested air pump efficiency voltage for effective generation of the target generated electric power of the fuel cell, in accordance with electric power when idle; and
adjusting the electric storage device voltage so as to be equal to the requested air pump efficiency voltage.

5. A fuel cell automobile comprising the fuel cell system according to claim 2.

6. The fuel cell system according to claim 2, further comprising:
an external electric power supply system comprising:
an external electric power supply inverter to which the primary side voltage is applied as external load driving voltage; and
an external load driven through the external electric power supply inverter.

7. A fuel cell system comprising:
a fuel cell to generate electricity through reaction of an oxidant gas and a fuel gas so as to output a fuel cell voltage;
electric storage means for outputting an electric storage means voltage;
a motor to be driven through a motor driving device;
voltage transduction means for converting from the electric storage means voltage to a motor driving voltage or from the motor driving voltage to the electric storage means voltage, the electric storage means voltage serving as a primary side voltage, the motor driving voltage serving as a secondary side voltage and being to be applied to the motor driving device;
an air pump to be driven through an air pump driving device so as to supply the oxidant gas to the fuel cell, the primary side voltage being to be applied to the air pump driving device; and
control means for setting a required air pump voltage to apply to the air pump driving device and for setting the electric storage means voltage so as to satisfy the required air pump voltage.
